(19) United States
(12) Patent Application Publication
(10) Pub. No.: US 2012/0252137 A1
(43) Pub. Date: Oct. 4, 2012

(54) Fluorescence Polarization Assay For Bacterial Endotoxin

(76) Inventors: Thomas James NOVITSKY, East Falmouth, MA (US); John Leroy SLOYER, JR., Cotuit, MA (US)

(21) Appl. No.: 13/437,913

(22) Filed: Apr. 2, 2012

Related U.S. Application Data
(60) Provisional application No. 61/470,736, filed on Apr. 1, 2011.

(51) Int. Cl. G01N 21/64

(52) U.S. Cl. 436/501

(57) ABSTRACT

The present invention comprises methods of detecting and quantifying bacterial endotoxin by using a tracer or a fluorescently labeled polymyxin wherein fluorescent tags include bodipy, NHS-fluorescein, FITC, 5-carboxyfluorescein, boron dipyrromethene, or tetramethylrhodamine. The polymyxins utilized include polymyxin B₁, B₂, D₂, E₁, E₂, F, M, Colistin and modifications thereof. The methods comprise mixing the fluorescently labeled polymyxin antibiotic with a bacterial endotoxin sample. Furthermore, the methods comprise steps of measuring fluorescence of fluorescently labeled polymyxin antibiotic and the bacterial endotoxin by using a fluorescent polarization endotoxin assay.

The current application claims a priority to the U.S. Provisional Patent application Ser. No. 61/470,736 filed on Apr. 1, 2011. The current application filed in U.S. Apr. 2, 2012 while Apr. 1, 2012 was on a weekend.

### FIELD OF THE INVENTION

The present invention relates generally to a method for detecting and quantifying bacterial endotoxin (lipopolysaccharide) using a chemically modified antibiotic. More particularly, the present invention is a method, which uses fluorescently labeled Polymyxin in a fluorescence polarization assay for bacterial endotoxin.

### BACKGROUND OF THE INVENTION

The present invention comprises a chemically modified antibiotic with high affinity to the endotoxin (lipopolysaccharide) component of certain bacteria. In particular, the preferred antibiotic includes all members of the class of antibiotic known as Polymyxin, which include Polymyxin B, D, E, F, Colistin and others. These antibiotics are peptides generally containing ten (10) amino acids and an alcohol. The various individual polymyxins contain different amino acid substitutions and different alcohols in certain locations. All classes however have a high binding affinity for endotoxin. For an endotoxin assay, a polymyxin is derivatized by the chemical addition of a fluorescent molecule. It is therefore an object of the present invention to introduce one or more fluorescent molecules to polymyxin by chemical addition in order to make polymyxin fluoresce without compromising endotoxin-binding affinity. Examples of fluorescent molecules used in this invention include, but are not limited to, fluorescein, 5-carboxy fluorescein, boron dipyrromethene, and tetramethylrhodamine.

When a fluorescent molecule is attached to polymyxin in a certain manner, the polymyxin retains its high affinity to bind endotoxin but also becomes visible when viewed with fluorescent light in a fluorometer. The assay, which comprises this invention, takes advantage of the polarization property of fluorescent molecules. That is when appropriate molecules are excited by a defined wavelength of light; the molecule is activated and emits light at a second defined wavelength (fluorescence). Such fluorescent molecules have the property of fluorescing in the 400-700 nm range. Further, if the excited light is polarized and the resulting emitted light is measured in the horizontal and vertical planes, a measure of the rate of optical rotation can be obtained (fluorescence polarization). The rate of optical rotation is inversely proportional to molecular volume, i.e. a smaller molecule will rotate faster than a larger one. Thus, in this invention, a relatively small molecule in solution, i.e. a fluorescently labeled polymyxin, will have a high rate of rotation. When this molecule binds to a relatively large molecule in solution, a namely bacterial endotoxin, the rotation will slow. Instruments exist to precisely measure fluorescence polarization.

### BRIEF DESCRIPTION OF THE DRAWINGS

FIG. 1 illustrates chemical structure of Polymyxin B.

FIG. 2 illustrates a sample number of photons and displays the formula used to calculate polarization or mP.

FIG. 3 illustrates a standard curve generated from measuring known concentrations of endotoxin samples.

FIG. 4 illustrates the formula obtained from generating a linear regression curve.

FIG. 5 illustrates the method of preparing fluorescently labeled polymyxin using bodipy.

FIG. 6 illustrates the method of preparing fluorescently labeled polymyxin using NHS-fluorescein.

FIG. 7 illustrates the method of preparing fluorescently labeled polymyxin using FITC.

FIG. 8 illustrates the method of performing a fluorescent polarization endotoxin assay.

FIG. 9 illustrates the generalized method of detecting endotoxin using the fluorescence polarization technique.

### DETAILED DESCRIPTIONS OF THE INVENTION

All illustrations of the drawings are for the purpose of describing selected versions of the present invention and are not intended to limit the scope of the present invention.

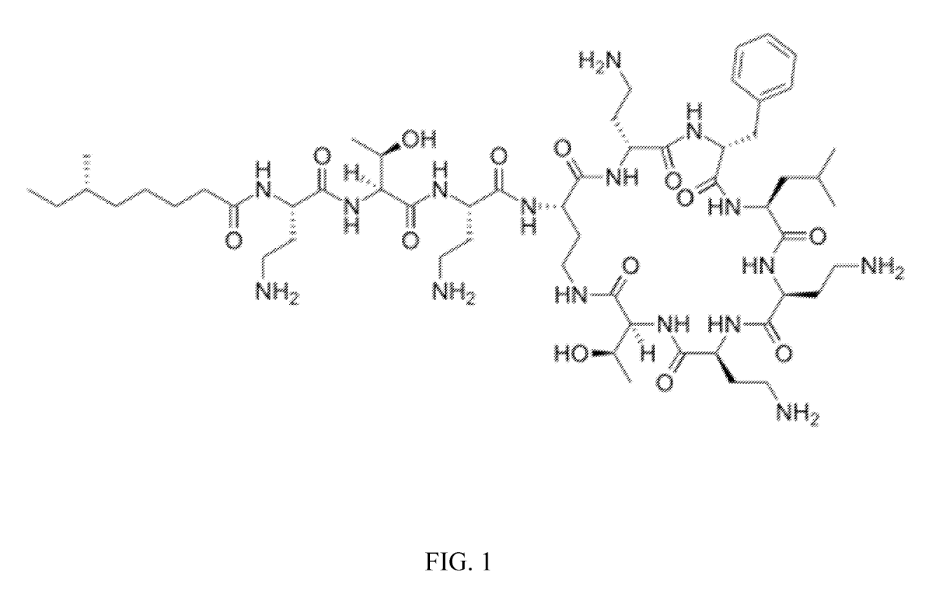

This invention comprises a chemically modified antibiotic with high and specific affinity to the endotoxin (lipopolysaccharide) component of certain bacteria. In particular, the preferred antibiotic includes all members of the class of antibiotics known as polymyxin, which include polymyxin B₁, B₂, D₂, E₁, E₂, F, M, Colistin and modifications thereof. The chemical structure of the polymyxin class is shown in FIG. 1. These antibiotics are peptides comprised of ten amino acids, five of which occur as a ring structure, and a terminal alcohol. The various individual polymyxins differ by amino acid and alcohol substitutions in certain locations in the peptide structure. All classes however have a high and specific binding affinity for endotoxin. For an endotoxin assay, a polymyxin is derivatized by chemical addition of a fluorescent molecule. The important feature for this chemical addition are the free amino (NH₂) groups that are available for coupling with a fluorescent molecule. There are numerous fluorescent molecules or tags that can be used including but not limited to: fluorescein, 5-carboxy fluorescein, boron dipyrromethene, and tetramethylrhodamine. Two of these are especially well adapted for the purpose of the assay. These are: boron dipyrromethene and fluorescein. To use the polymyxin derivative as a tracer in the subject of the present invention, one or more of the free amino groups are coupled with a fluorescent molecule. The actual number and location of the fluorescently-coupled amino groups can be controlled to a certain extent by physically and/or chemically varying the conditions of coupling. The resulting tracer however is normally a mixture of derivatives of polymyxin ranging from a single fluorescently-labeled polymyxin molecule to multiple fluorescently-labeled molecules with a range from 1 to 5 fluorescent molecules per polymyxin molecule with a range of labeled positions. Thus, the tracer useful in this application is actually a mixture of compounds. In the preferred mixture, the present invention contains an average equaling 3 fluorescent molecules per molecule of polymyxin. The preferred mixture is obtained using a molecular ratio of 15 molecules of fluorescent label to 1 molecule of polymyxin during the coupling process. To further enhance the optimal reactivity of the tracer in various solutions, the labeled polymyxin can be separated into fractions of identical derivatives using preparative gas chromatography. The preferred fraction for a tracer if preparative gas chromatography is used is 3 fluorescent molecules per polymyxin molecule.

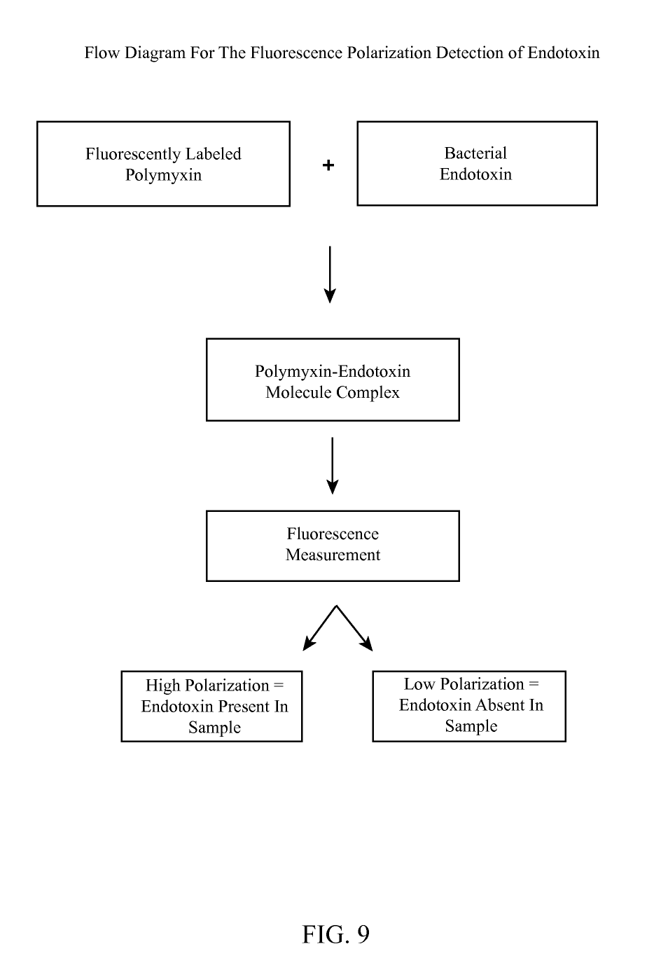

The present invention includes methods of detecting and quantifying bacterial endotoxin by using a tracer or a fluorescently labeled polymyxin wherein fluorescent tags include 4,4-difluoro-5,7-dimethyl-4-bora-3a,4a-diaza-s-indacene-3-pentanoic acid, succinimidyl ester (bodipy); 5/6-carboxyfluorescein succinimidyl ester (NHS-fluorescein); 5(6)-fluorescein isothiocyanate (FITC); 5-carboxy fluorescein; boron dipyrromethene; or tetramethyl rhodamine. The methods comprise steps in derivatizing polymyxin with fluorescent tag bodipy, NHS-fluorescein or FITC are specified hereinafter. The method of derivation varies depending on the fluorescent tag employed. The methods comprise mixing the fluorescently labeled polymyxin antibiotic with a bacterial endotoxin sample. Moreover, the methods comprise steps of measuring fluorescence of fluorescently labeled polymyxin antibiotic and the bacterial endotoxin by using a fluorescent polarization endotoxin assay. The generalized method of detecting endotoxin using fluorescence polarization technique is illustrated in FIG. 9.

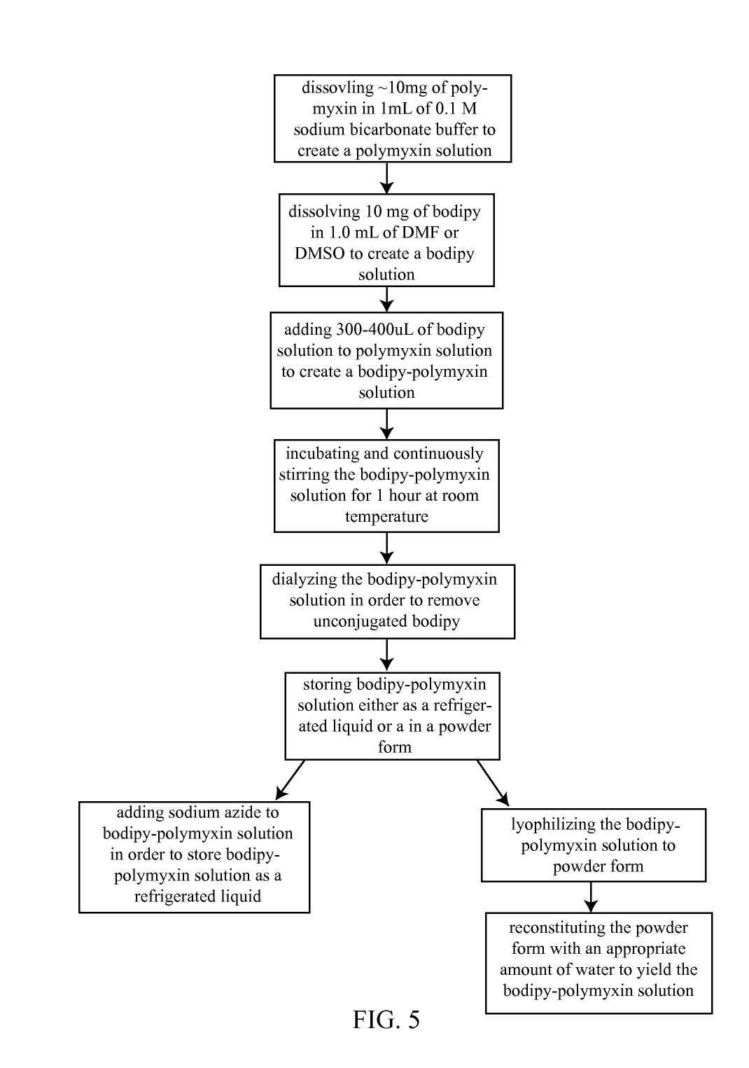

In the preferred method of derivatizing polymyxin with fluorescent tag bodipy, a preferred form of bodipy named water soluble succinyl ester of bodipy or 4,4-difluoro-5,7-dimethyl-4-bora-3a,4a-diaza-s-indacene-3-propionic acid, sulfosuccinimidyl ester is used. The method of preparing fluorescent tracer with bodipy is initiated by dissolving approximately 10 mg of polymyxin in 1 mL of 0.1M sodium bicarbonate buffer to create a polymyxin solution. The polymyxin solution is completely mixed and dissolved with the aid of a vortex. The polymyxin solution is then set aside. Next, a bodipy solution is created by dissolving 10 mg of bodipy in 1.0 mL of dimethylformamide (DMF) or dimethylsulfoxide (DMSO). The dissolution of 10 mg of bodipy in DMF or DMSO is preferably aided by utilization of a vortex. The polymyxin solution is mixed with the bodipy solution to initiate conjugation between the antibiotic polymyxin and the fluorescent tag bodipy. Then, 300-400 μL of the bodipy solution is added to the polymyxin solution while the polymyxin solution is being vortexed to create a bodipy-polymyxin solution. Varying the amount of bodipy solution added will result in more or less amino groups being labeled. Vortexing allows the polymyxin solution and the bodipy solution to mix well so high amount of byproducts may be yielded. After vortexing, the bodipy-polymyxin solution is incubated and continuously stirred for one hour at room temperature. Then, the bodipy-polymyxin solution is dialyzed in order for the unconjugated bodipy to be removed. The bodipy-polymyxin solution is then stored either as a refrigerated liquid or in a powder form. If stored as a refrigerated liquid, sodium azide is added as a preservative to the bodipy-polymyxin solution in order to prevent microbial contamination. In order to transform the bodipy-polymyxin solution into a powder form, lyophilizing is utilized. Lyophilizing or freeze-drying is a dehydration process used to preserve a perishable material or make the material more convenient for transport. Lyophilizing works by freezing the material and reducing the surrounding pressure to allow frozen water in material to transform directly from solid phase to gas phase. As a powder form, the bodipy-polymyxin solution may be reconstituted with an appropriate amount of water. The method of preparing fluorescent tracer with bodipy is illustrated in FIG. 5.

The method of preparing the fluorescent tracer with NHS-fluorescein is initiated by dissolving approximately 10 mg of polymyxin in 1 mL of 0.1M sodium bicarbonate buffer in order to create a polymyxin solution. Then, a NHS-fluorescein solution is created by reconstituting 1 mg of powder NHS-fluorescein with 100 μL of DMF or DMSO. The act of weighing and transferring the powder NHS-fluorescein into DMF or DMSO is done immediately to protect NHS-fluorescein from moisture since powder NHS-fluorescein is hygroscopic and its ability to form derivatives degrades rapidly in the presence of moisture. Subsequently, the NHS-fluorescein solution is mixed with the polymyxin solution in order to create a NHS-fluorescein polymyxin solution. The amount of NHS-fluorescein solution to use for each reaction depends on the amount of the polymyxin solution to be labeled. By using the appropriate molar ratio of labeling reagent to polymyxin, the extent of conjugation can be controlled. When conjugating polymyxin with NHS-fluorescein, a 15-to-20-fold molar excess of the fluorescein is optimal; however, this ratio may be varied to alter the degree of labeling. The molar concentration of the NHS-fluorescein solution to be added to the polymyxin solution is at least 15 times the molar concentration of the polymyxin solution. The molar excess may be calculated by using the following equation:

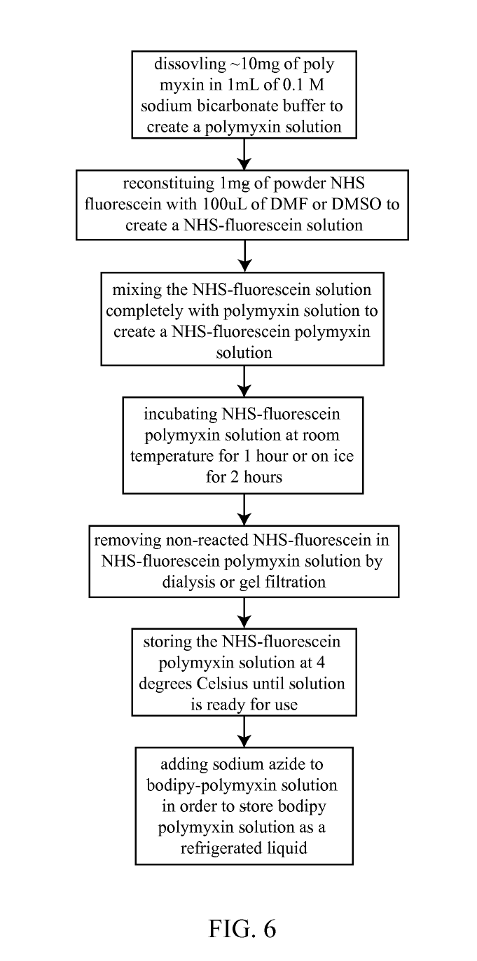

molar excess=mL polymyxin*mg polymyxin*mmol polymyxin*15 mmol NHS-fluorescein

where the molecular weight of NHS-fluorescein is 473.4 and the molecular weight of polymyxin depends on the type of polymyxin used. In the preferred method, polymyxin B was used, therefore 1301.56 was used as the molecular weight for polymyxin. The NHS-fluorescein polymyxin solution is incubated at room temperature for one hour or on ice for two hours. Then, non-reacted NHS-fluorescein in the NHS-fluorescein polymyxin solution is removed by dialysis or gel filtration. The NHS-fluorescein polymyxin solution is then stored at 4 degrees Celsius until the NHS-fluorescein polymyxin solution is ready for use. Similarly to the bodipy-polymyxin solution, a final concentration of 0.1% of sodium azide is added as a preservative to the NHS-fluorescein polymyxin solution to prevent microbial contamination in the NHS-fluorescein polymyxin solution. The method of preparing the fluorescent tracer NHS-fluorescein includes utilizing 50 mM borate with a pH 8.5 as the optimal labeling buffer. Other non-amine-containing buffers include buffers with pH between 7-9 such as 20 mM sodium phosphate, 0.15 M NaCl, 20 mM HEPES and 100 mM carbonate/bicarbonate may be used. The method of preparing the fluorescent tracer with NHS-fluorescein is illustrated in FIG. 6.

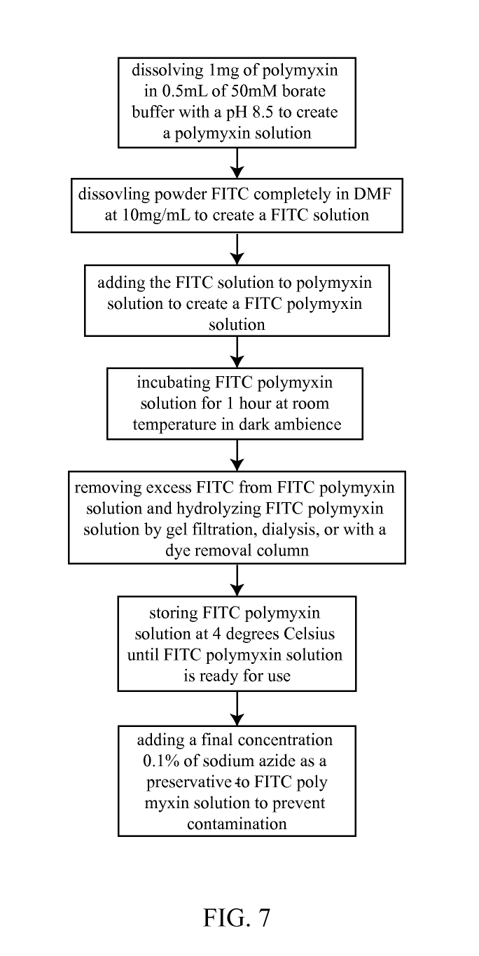

The method of preparing the fluorescent tracer with FITC is initiated by dissolving 1 mg of polymyxin in 0.5 mL of 50 mM borate buffer with a pH 8.5 in order to create a polymyxin solution. The fluorescent tag FITC is dissolved in DMF at 10 mg/mL and mixed to complete dissolution to create a FITC solution. The FITC solution is added to the polymyxin solution with 15-to-20-fold molar excess of the FITC solution in a FITC polymyxin solution. The molar excess may be calculated by using the aforementioned equation used in calculating the molar excess of the NHS-fluorescein with a molecular weight 389.38 for FITC. The FITC polymyxin solution is thoroughly mixed. Subsequently, the FITC polymyxin solution is incubated for one hour at room temperature in dark ambience. The excess FITC is removed from the FITC polymyxin solution by hydrolyzing the FITC polymyxin solution through gel filtration, dialysis, or with a dye removal column. Consequently, the FITC polymyxin solution is stored at 4 degrees Celsius until the FITC polymyxin solution is ready for use. A final concentration of 0.1% of sodium azide is added as a preservative to the FITC polymyxin solution to prevent microbial contamination in the FITC polymyxin solution. The method of preparing the fluorescent tracer with FITC is illustrated in FIG. 7.

The method of measuring fluorescence of the fluorescently labeled polymyxin antibiotic and bacterial endotoxin by using a fluorescent polarization endotoxin assay is initiated by diluting endotoxin in endotoxin-free distilled water to cover a range of concentrations from 0 Endotoxin Units (EU)/mL to 100 EU/mL in order to create a plurality of endotoxin samples. The plurality of endotoxin samples is evenly distributed into each of a plurality of cuvettes. Each of the plurality of cuvettes contains 3 mL of the plurality of endotoxin samples. Subsequently, 10 μL to 100 μL of fluorescently labeled polymyxin is added into each of the plurality of cuvettes. The concentration of tracer or fluorescently labeled polymyxin to add to a 3 mL volume of endotoxin sample in each of the plurality of cuvettes is calculated so that the final number of photons displayed in the parallel channel of the fluorescence polarization meter ranges from 6-8 millions. Consequently, the volume of tracer to add to 3 mL volume should be adjusted to range from 10 μL to a maximum of 100 μL. In order to measure accurate fluorescent signals, a noise signal is measured first. The noise signal may be obtained from measuring an endotoxin sample with water or buffer without the labeled polymyxin antibiotic using a fluorescence polarization instrument. The method to use the fluorescence polarization instrument is described in detail in U.S. Pat. No. 4,429,230. A fluorescent signal may be obtained from measuring a sample containing the fluorescently-labeled polymyxin antibiotic or tracer plus endotoxin in the fluorescence polarization instrument. Subsequently, the noise signal is subtracted from the fluorescent signal to obtain a plurality of fluorescence results or net photons.

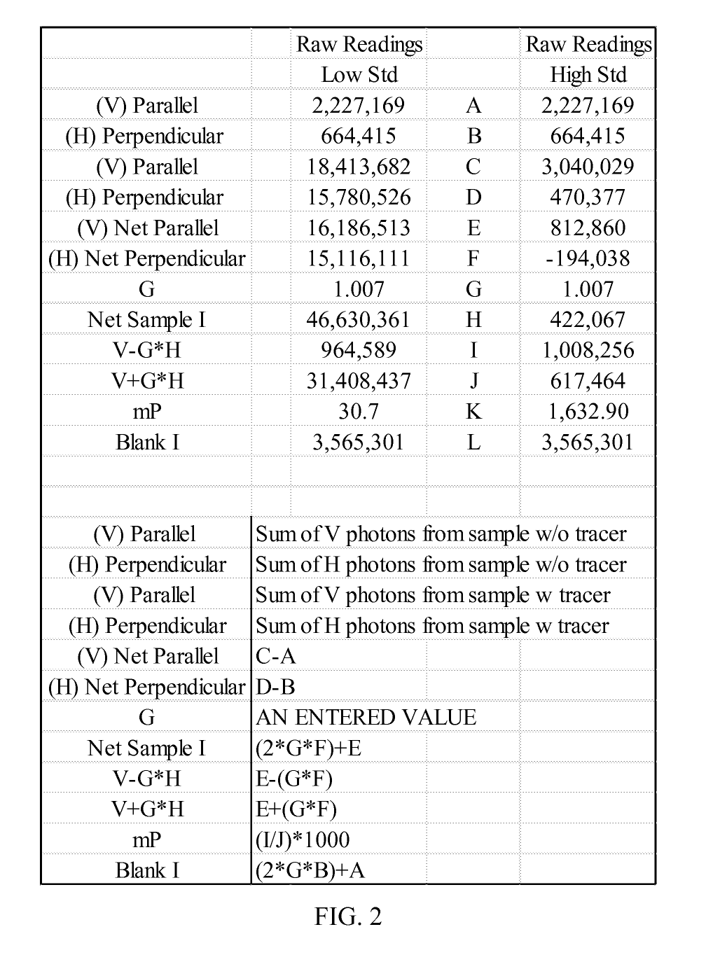

The net photons obtained in each channel in the instrument are used to calculate polarization (mP) as illustrated in FIG. 2. FIG. 2 illustrates a sample number of photons and displays the formula used to calculate the mP. The G value is a correction factor unique to each instrument and is used to equilibrate physical optical differences among instruments. As illustrated in FIG. 2, sum of photons from sample without tracer was measured in vertical and horizontal planes. Sum of photons from sample with tracer was also measured in both vertical and horizontal planes. Subsequently, sum of photons without tracer in vertical plane is subtracted from sum of photons with tracer in vertical plane to produce a net photons in vertical plane or (V) net parallel. Similarly, the net photons in horizontal plane or (H) net perpendicular is calculated by obtaining the difference between the sum of photons with tracer in horizontal plane and the sum of photons without tracer in horizontal plane. Consequently, the net photons of sample in both vertical and horizontal planes is calculated by using the following formula:

net photons of sample=(2*G factor*(H) net perpendicular)+(V) net parallel

Polarization or mP of the sample is calculated by using the following formula:

mP=[((V) net parallel−(G factor*(H) net perpendicular))/((V) net parallel+(G factor*(H) net perpendicular))]*(1000)

Additionally, in order to find the net photons of a blank sample, the summation of (V) parallel or the sum of photons from sample without tracer in the vertical plane and (H) parallel or the sum of the photons from sample without tracer in horizontal plane is carried out as follows:

Photons of blank sample=(2*G factor*(H) perpendicular)+(V) parallel

A standard curve is generated by measuring the mP of a plurality of endotoxin samples with the following known concentrations 0, 1, 2, 5, 10, 25, 50, 100 EU/mL in pyrogen-free water or buffer. An example of a lower end standard curve is shown Table 1 below:

TABLE 1

| EU in the cuvette | EU/ml | V-photons | H-photons | mP |
|---|---|---|---|---|
| 0 | 0.00 | 7,134,520 | 5,079,601 | 60 |
| 1 | 0.34 | 5,931,542 | 3,839,199 | 95 |
| 5 | 1.67 | 6,163,584 | 3,501,121 | 163 |

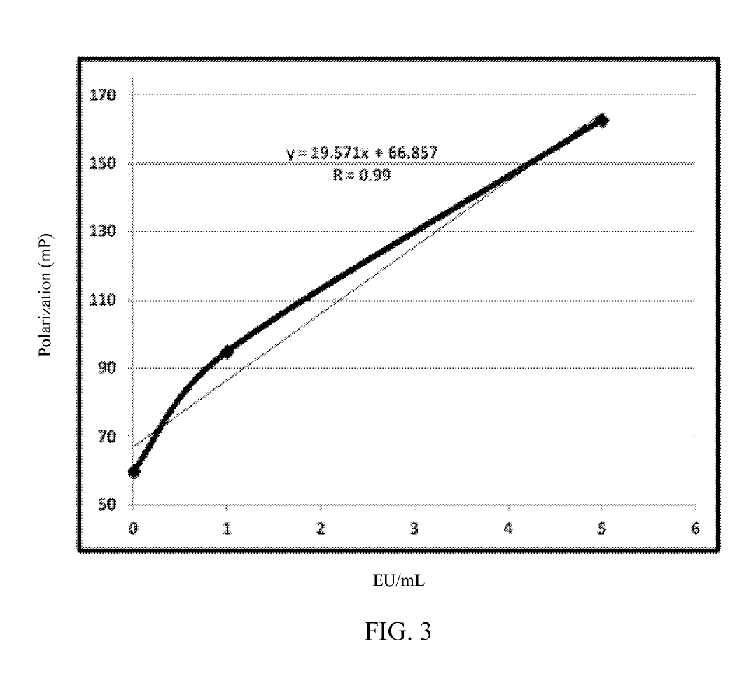

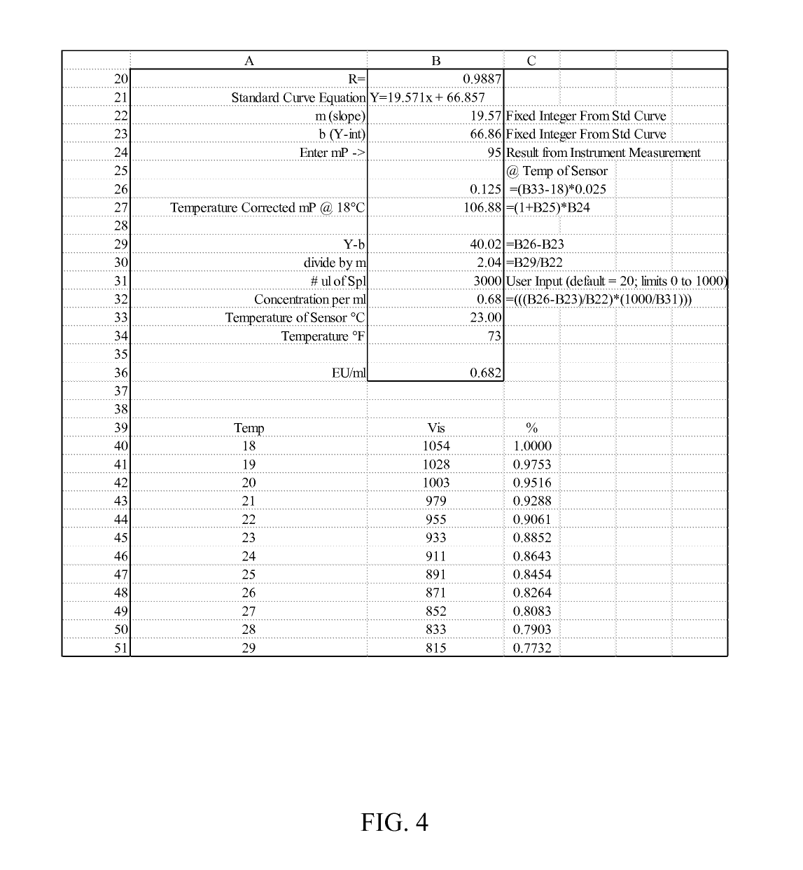

The standard curve generated by the data is shown in FIG. 3. The concentration of endotoxin can be determined from a linear regression formula similar to the linear regression formula in FIG. 3. For example, a change in mP from 60 to 95 mP would indicate that the solution has approximately 0.479 EU/mL. A formula obtained from generating a linear regression curve is shown in FIG. 4 and how temperature may affect the result. The plurality of fluorescence results are calibrated accordingly to temperature of the endotoxin samples. Since mP varies with the temperature in a water solution, the formula is shown for compensating for this viscosity change. Since the standard curve is generated at a temperature of 18 degrees Celsius, all measurements made above 18 degrees Celsius will have a decrease in viscosity, therefore an increase in mP, and a corrected increase in EU/mL. Thus, a reading of 95 mP at 23 degrees Celsius would be corrected to 0.682 EU/mL rather than 0.479 EU/mL uncorrected. The calculation for the corrected concentration of endotoxin measured is carried out as follows:
1. a standard curve equation is obtained from the standard curve
2. an mP value is obtained from instrument measurement at temperature sensor. The step to find mP has been explained previously and is found in FIG. 2.
3. A correction factor is obtained to account for the temperature difference between the temperature of the sensor and the temperature of fluid sample. This correction factor is obtained by using the following formula:

correction factor=(temperature of sensor ° C.−temperature of fluid sample ° C.)*0.025
As illustrated in FIG. 4, the correction factor accounting for the temperature difference between that of the sensor and that of the fluid sample is 0.125.
4. Corrected polarization or mP of the fluid sample is obtained by using the following formula:

temperature corrected mP=(1+correction factor)*mP from step 2
As illustrated in FIG. 4, temperature corrected mP at 18 degrees Celsius, which is the temperature of the fluid sample, has been found to be 106.99 mP. The temperature of the fluid is greatly dependent on the viscosity of the fluid as shown in the temperature and viscosity table in FIG. 4.
5. The corrected amount of endotoxin or EU/mL is found by using the following formula:

corrected EU/mL=[(temperature corrected mP−y intercept of standard curve)/(slope of standard curve)]*(1000/#μL of sample)
where the y intercept of the standard curve is polarization of a blank sample or when there is no presence of endotoxin in the sample, and the slope of the standard curve is the change in polarization based on the concentration of endotoxin in the sample. As illustrated in FIG. 4, the y intercept of the standard curve is 66.86 mP and the slope of the standard curve is 19.57 mPmL/EU. As calculations of FIG. 4 illustrate, temperature of the fluid sample is especially important in determining the corrected concentration of endotoxin present in the sample.

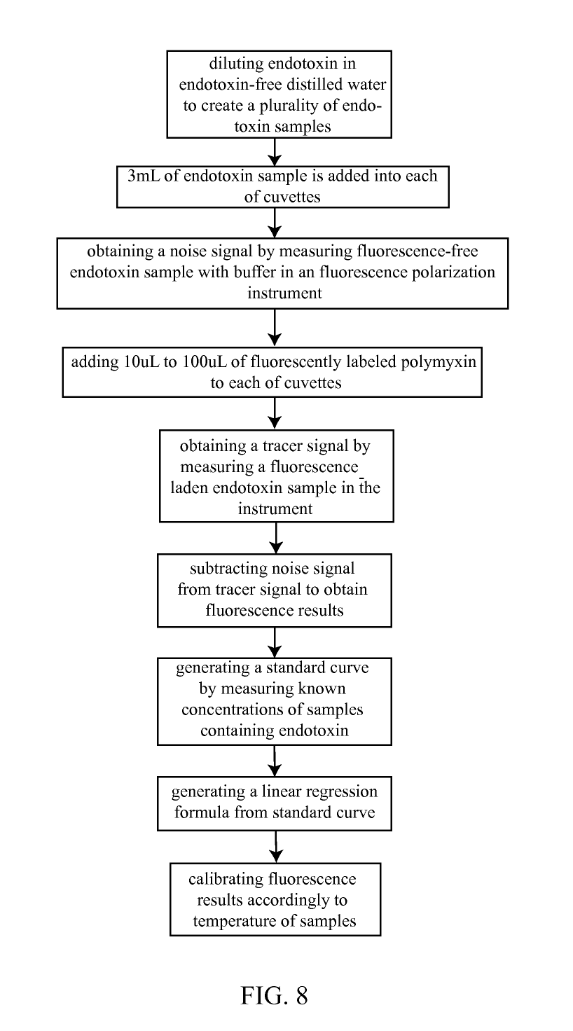

Fluorescence results can also be displayed as PASS/FAIL depending on the cutoff for any given application. Generally, an mP increase from the “zero” point of greater than 10%-20% would indicate positive. In this system, such an increase would indicate an endotoxin concentration of approximately 0.25 EU. The method of performing the fluorescent polarization endotoxin assay is illustrated in FIG. 8. As FIG. 9 illustrates, high polarization could indicate a high amount of endotoxin present in the sample or that low polarization could indicate the absence of endotoxin in the sample.

Although the invention has been explained in relation to its preferred embodiment, it is to be understood that many other possible modifications and variations can be made without departing from the spirit and scope of the invention as hereinafter claimed.

What is claimed is:

1) A method of detecting and quantifying bacterial endotoxin (lipopolysaccharide) by using a fluorescently labeled polymyxin antibiotic tracer comprises the steps of:
a) preparing a fluorescently labeled polymyxin antibiotic with fluorescent tags, wherein the fluorescent tags can be 4,4-difluoro-5,7-dimethyl-4-bora-3a,4a-diaza-s-indacene-3-pentanoic acid, succinimidyl ester (bodipy), 5/6-carboxyfluorescein succinimidyl ester (NHS-fluorescein), 5(6)-fluorescein isothiocyanate (FITC), 5-carboxyfluorescein, boron dipyrromethene, or tetramethylrhodamine;
b) mixing the fluorescently labeled polymyxin antibiotic with a bacterial endotoxin sample; and
c) quantifying fluorescence of the fluorescently labeled polymyxin antibiotic and the bacterial endotoxin sample by using a fluorescent polarization endotoxin assay.

2) The method of claim 1 wherein the polymyxin antibiotic tracer includes Polymyxin B₁, B₂, D₁, D₂, E₁, E₂, F, M Colistin and modifications thereof.

3) The method of claim 1 wherein step (a) in preparing fluorescent tracer bodipy comprises the steps of:
a) dissolving approximately 10 mg of polymyxin in 1 mL of 0.1M sodium bicarbonate buffer in order to create a polymyxin solution;
b) dissolving 10 mg of bodipy in 1.0 mL of dimethylformamide (DMF) or dimethylsulfoxide (DMSO) in order to create a bodipy solution;
c) adding 300-400 μL of the bodipy solution to the polymyxin solution while vortexing the polymyxin solution in order to create a bodipy-polymyxin solution;
d) incubating and continuously stirring the bodipy-polymyxin solution for 1 hour at room temperature;
e) dialyzing the bodipy-polymyxin solution in order to remove unconjugated bodipy; and
f) storing the bodipy-polymyxin solution either as a refrigerated liquid or in a powder form.

4) The method of claim 3 wherein step (b) in preparing the bodipy solution comprises the steps of:
a) mixing the bodipy solution briefly by vortexing; and
b) dissolving the bodipy immediately and completely before initiating the bodipy-polymyxin solution.

5) The method of claim 3 wherein step (c) includes varying the amount of the bodipy solution added to the polymyxin solution to result in more or less amino groups being labeled.

6) The method of claim 3 wherein step (f) includes adding sodium azide to the bodipy-polymyxin solution in order to store the bodipy-polymyxin solution as a refrigerated liquid.

7) The method of claim 3 wherein step (f) includes the steps of:
a) lyophilizing the bodipy-polymyxin solution to powder form; and
b) reconstituting the powder form with an appropriate amount of water to yield the bodipy-polymyxin solution.

8) The method of claim 1 wherein step (a) in preparing the fluorescent tracer NHS-fluorescein comprises the steps of:
a) dissolving approximately 10 mg of polymyxin in 1 mL of 0.1M sodium bicarbonate buffer in order to create a polymyxin solution;
b) reconstituting 1 mg of powder NHS-fluorescein with 100 μL of DMF or DMSO in order to create a NHS-fluorescein solution;
c) mixing the NHS-fluorescein solution completely with the polymyxin solution in order to create a NHS-fluorescein polymyxin solution;
d) incubating the NHS-fluorescein polymyxin solution at room temperature for 1 hour or on ice for 2 hours;
e) removing non-reacted NHS-fluorescein in the NHS-fluorescein polymyxin solution by dialysis or gel filtration;
f) storing the NHS-fluorescein polymyxin solution at 4 degrees Celsius until the NHS-fluorescein polymyxin solution is ready for use; and
g) adding a final concentration of 0.1% of sodium azide as a preservative to the NHS-fluorescein polymyxin solution to prevent microbial contamination.

9) The method of claim 8 wherein step (b) includes protecting powder NHS-fluorescein from moisture and transferring powder NHS-fluorescein quickly into DMF or DMSO.

10) The method of claim 8 wherein the molar concentration of the NHS-fluorescein solution is at least 15 times the molar concentration of the polymyxin solution.

11) The method of claim 10 wherein the molar excess is calculated by using the following equation: mL polymyxin×mg polymyxin×mmol polymyxin×15 mmol NHS-fluorescein where 473.4 is the molecular weight of the NHS-fluorescein solution.

12) The method of claim 8 wherein optimal labeling buffer is 50 mM borate with a pH 8.5.

13) The method of claim 8 wherein other non-amine-containing buffers with a pH between 7-9 wherein 20 mM sodium phosphate, 0.15 M NaCl, 20 mM HEPES or 100 mM carbonate/bicarbonate may be used.

14) The method of claim 1 wherein step (a) in preparing the fluorescent tracer with FITC comprises the steps of:
a) dissolving 1 mg of polymyxin in 0.5 mL of 50 mM borate buffer with a pH 8.5 in order to create a polymyxin solution;
b) dissolving powder FITC completely in DMF at 10 mg/mL to create a FITC solution;
c) adding 15-to-20-fold molar excess of the FITC solution to the polymyxin solution and immediately mixing the FITC solution and the polymyxin solution in order to create a FITC polymyxin solution;
d) incubating the FITC polymyxin solution for 1 hour at room temperature in dark ambience;
e) removing excess FITC from the FITC polymyxin solution by treating the FITC polymyxin solution with gel filtration, dialysis, or with a dye removal column;
f) storing the FITC polymyxin solution at 4 degrees Celsius until the FITC polymyxin solution is ready for use; and
g) adding a final concentration of 0.1% of sodium azide as a preservative to the FITC polymyxin solution to prevent microbial contamination.

15) The method of claim 14 wherein step (c) in calculating the molar excess of the FITC solution is achieved by utilizing the following equation: mL polymyxin×mg polymyxin×mmol polymyxin×15 mmol FITC with a molecular weight 389.38 for FITC solution.

16) The method of claim 1 wherein step (c) in performing the fluorescent polarization endotoxin assay comprises the steps of:
a) diluting endotoxin in endotoxin-free distilled water or buffer to cover a range of concentrations from 0 Endotoxin Units (EU)/mL to 100 EU/mL in order to create a plurality of endotoxin samples;
b) 3 mL of the plurality of endotoxin sample is added into each of a plurality of cuvettes;
c) adding 10 μL to 100 μL of the fluorescently labeled polymyxin to each of the plurality of cuvettes;
d) obtaining a noise signal by measuring a fluorescence-free endotoxin sample with endotoxin-free distilled water or buffer in an fluorescence polarization instrument;
e) obtaining a fluorescent signal by measuring a fluorescence-laden endotoxin sample in the fluorescence polarization instrument;
f) subtracting the noise signal from the fluorescent signal to obtain fluorescence results;
g) generating a standard curve by measuring known concentrations of endotoxin containing 0, 1, 2, 5, 10, 25, 50, 100 EU/mL in pyrogen-free water or buffer;
h) generating a linear regression formula from the standard curve; and
i) calibrating the fluorescence results accordingly to temperature of the plurality of endotoxin samples.
